(19) United States
(12) Patent Application Publication
(10) Pub. No.: US 2021/0341021 A1
(43) Pub. Date: Nov. 4, 2021

(54) TORSIONAL VIBRATION DAMPER

(71) Applicant: Schaeffler Technologies AG & Co. KG, Herzogenaurach (DE)

(72) Inventors: Ralf Edl, Achern (DE); Artem Kerber, Lahr (DE)

(73) Assignee: Schaeffler Technologies AG & Co. KG, Herzogenaurach (DE)

(21) Appl. No.: 17/286,563

(22) PCT Filed: Oct. 17, 2019
(86) PCT No.: PCT/DE2019/100905

§ 371 Date: Apr. 19, 2021

(30) Foreign Application Priority Data
Oct. 23, 2018 (DE) 102018126376.7

(51) Int. Cl. F16D 3/12; F16F 15/131; F16F 15/121

(52) U.S. Cl. CPC F16D 3/12; F16D 3/06; F16F 15/121; F16F 15/13171

(57) ABSTRACT

A torsional vibration damper, in particular for a drive train of a motor vehicle having a dual clutch transmission, includes an input part mounted rotatably about a rotation axis, and an output part rotatable in relation to the input part about the rotation axis to a limited extent against the action of a spring device and which has an output hub. A rolling bearing is provided between the input part and the output part, the output hub is divided into a ring part, which contains an output-side bearing seat, and a hub part, which contains internal teeth.

### CROSS-REFERENCE TO RELATED APPLICATIONS

This application is the U.S. National Phase of PCT Appln. No. PCT/DE2019/100905 filed Oct. 17, 2019, which claims priority to DE 102018126376.7 filed Oct. 23, 2018, the entire disclosures of which are incorporated by reference herein.

### TECHNICAL FIELD

The disclosure relates to a torsional vibration damper, in particular for a drive train of a motor vehicle with a dual clutch transmission, with an input part which is mounted rotatably about an axis of rotation, and with an output part which is rotatable in relation to the input part about the axis of rotation to a limited extent against the action of a spring device and which has an output hub.

### BACKGROUND

Torsional vibration dampers function to isolate torsional vibrations, in particular in drive trains with internal combustion engines subject to torsional vibrations. For this purpose, a torsional vibration damper, designed for example as a dual-mass flywheel, is accommodated on the crankshaft of the internal combustion engine in a rotationally fixed way by means of an input part. An output part transmits the torque, introduced into the input part in a traction mode in the input part, to a downstream drive train device, for example, a dual clutch of a dual clutch transmission. A spring device, which acts in the circumferential direction and temporarily stores the energy from the torsional vibration amplitudes, is connected between the input part and the output part so that the torque, of the internal combustion engine which is subject to torsional vibrations, is calmed as a whole.

Generic torsional vibration dampers are known from the publications WO 2018/149 430 A1 and DE 10 2017 126 747 A1, in which the output part contains an output hub with an internal toothing which is connected in a rotational locking way to a shaft or a shaft stub of a downstream drive train device. In this case, the input part is centered with respect to the axis of rotation of the crankshaft, and the output part is centered with respect to the axis of rotation of the transmission side shaft, for example, the transmission input shaft.

### SUMMARY

The object of the disclosure is to further develop a generic torsional vibration damper. In particular, the object of the disclosure is to propose an economical mounting of the output part on the input part of a torsional vibration damper.

The object is described by the subject matter of the claims. The claims represent advantageous embodiments of the subject matter disclosed herein.

The proposed torsional vibration damper is used for torsional vibration isolation, in particular for a drive train of a motor vehicle, for example, having a dual clutch transmission and an internal combustion engine subject to torsional vibrations. For this purpose, the torsional vibration damper contains an input part rotatably accommodated about an axis of rotation. The input part is accommodated on the crankshaft, for example, by means of screws reaching through fastening openings of the input part and screwed to a crankshaft of the internal combustion engine. The input part may be designed as a primary flywheel mass, to which, for example, multiple disc parts, designed as sheet metal parts, a starter ring gear, ring masses, and/or the like contribute. For example, an annular chamber, which is open inwardly, may be designed from two disc parts, in which chamber a spring device of the torsional vibration damper is accommodated. Furthermore, axially opposite impressions or other stops which axially limit the annular chamber may be provided on the disk parts, said stops biasing spring elements, like bow springs or bow spring assemblies having bow springs nested in one another and arranged distributed across the circumference, on the input side in the circumferential direction. For this purpose, corresponding impressions, which respectively engage between adjacent end faces of the bow springs in the circumferential direction, may be provided in a corresponding division of the bow springs.

The output part is arranged to be relatively rotatable about the axis of rotation in relation to the input part and against the action of the spring device, and has biasing means on the output side, for example, radially extended arms on a flange part of the output part, said arms axially penetrating between the impressions of the input part and engaging between the end faces of adjacent bow springs in the circumferential direction. The flange part is one piece with the output hub or is connected to the output hub by means of a main rivet.

The output hub has an internal toothing, which is connectable in a rotationally locking manner to an external toothing of a shaft or a shaft stub of a downstream drive train device, for example, a dual clutch, a hydrodynamic torque converter, or the like.

The output part may have a secondary flywheel mass so that a dual mass flywheel effect is designed with the primary flywheel mass of the input part. The secondary flywheel mass may be provided completely on the output part or assigned to the same. An assignment of at least a part of the secondary flywheel mass may be provided by means of the rotationally locked connection of the drive train device and its mass moment of inertia. At least one part of the mass provided on the output part may be designed, for example, as a ring mass accommodated on the main rivet. Alternatively or additionally, a pendulum mass carrier of a centrifugal force pendulum adjusted to a predefined order of damping may be accommodated on the main rivet.

To seal the annular chamber and to establish a base friction, a plate spring diaphragm may be accommodated between the flange part and the output hub, in particular on the main rivet, and may be axially prebiased in relation to a disc part designed as a cover part of the annular chamber.

In order to mount the input part and the output part coaxially about the axis of rotation of the crankshaft, a rolling bearing, for example, a grooved ball bearing, a tapered ball bearing, or a similar rotary bearing providing an axial mounting, is provided between the input part and the output part. A tolerance-related axis offset, for example, designed if necessary between the axis of rotation of the crankshaft and a transmission-side connecting shaft, for example, one or more transmission input shafts of a dual clutch transmission, may be compensated within the drive train device, for example, of a dual clutch, connecting to the output hub.

To form a simple mounting by means of the rolling bearing and the corresponding input side and output side bearing seats for the rolling bearing, the output hub is designed as divided into a ring part containing an output-side bearing seat and a hub part containing an internal toothing. The output hub designed in this way as two parts may be produced more easily and economically, despite a necessary joining process of the ring part and the hub part, than, for example, an output hub produced as one part, for example, by means of a forging process with subsequent machining.

In one preferred embodiment of the output hub, the ring part and the hub part are riveted to each other. During the riveting process, the ring part and the hub part are held down on one another, coaxially centered on the axis of rotation.

The riveting of the ring part to the hub part is carried out by means of rivets arranged distributed across the circumference, preferably at a radius of a partial circle, which corresponds substantially to the radius of a partial circle of fastening openings in the input part, for example, a disk part, to which the torsional vibration damper is fastenable to a crankshaft of an internal combustion engine or another drive train part by means of screws penetrating the fastening openings. The rivets may hereby be arranged in the circumferential direction between the screws.

The bearing seats for the rolling bearing may be designed in such a way that an inner ring of the rolling bearing is accommodated on an output-side bearing seat and the outer ring is accommodated on an input-side bearing seat. However, in particular for reasons related to installation space, the provision of the output-side bearing seat, the assembly and the like, the outer ring of the rolling bearing is accommodated in a preferred way on the bearing seat of the ring part and supported axially on the hub part immediately radially outside of the internal toothing. The inner ring of the rolling bearing is correspondingly accommodated on the bearing seat of the input part. The bearing seats may be designed as press fits. Before the joining the mounting, the rolling bearing may be accommodated on the output-side bearing seat. During the joining of the output part onto the input part, the inner ring may thereby be axially supported by the internal toothing so that the rolling bearing is not excessively loaded. The bearing seat may be designed on a bearing dome of the input part, which is connected to a disk part of the input part. The bearing dome may likewise have a reinforcing ring for fastening the input part by means of the fastening openings. The bearing dome may be riveted to the disc part or may merely be captively accommodated on the same, and the fixed connection of the bearing dome to the disc part may be carried out by means of the screws during the fastening the torsional vibration damper.

The ring part may be produced from sheet metal, for example, may be stamped and shaped. A shape with an L-shaped cross section may hereby be formed with two legs arranged substantially at right angles to each other, wherein one leg is riveted to the hub part and the other leg has the bearing seat. The bearing seat may be attached to the leg, for example, by calibration, for example, by stretching or the like, using tools or by means of machining.

The hub part may be produced from sheet metal, for example, may be stamped and shaped. After the stamping and shaping process, the internal toothing may be produced, machined by means of a broaching method. Alternatively, the production of the internal toothing may be provided using tools, in that the internal toothing is introduced in the shaping process by means of material displacement or pushing.

### BRIEF DESCRIPTION OF THE DRAWINGS

The disclosure is explained in more detail with reference to the exemplary embodiment shown in FIGS. 1 and 2. In the figures:

FIG. 1 shows a part of a torsional vibration damper arranged about an axis of rotation in a cross-sectional view

and

FIG. 2 shows a detail of the torsional vibration damper from FIG. 1.

### DETAILED DESCRIPTION

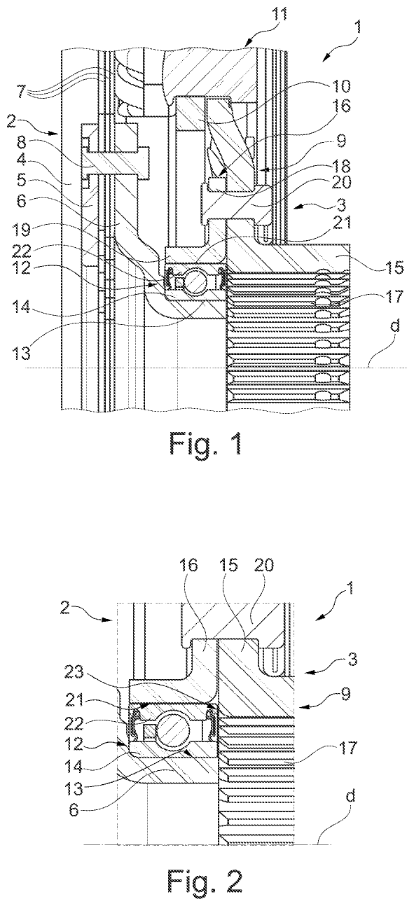

FIG. 1 shows the upper part of torsional vibration damper 1, arranged rotatably about the axis of rotation d in a cross-sectional view, with input part 2 and output part 3 arranged to be relatively rotatable about the axis of rotation d against a spring device. The upper part of torsional vibration damper 1 with the spring device, optionally a ring mass and/or a centrifugal force pendulum, corresponds to the specified prior art.

Input part 2 contains drive plate 4, reinforcement disc 5, bearing dome 6, and axially elastic drive plates 7 layered on one another, which are connected to each other by means of rivets 8 arranged distributed across the circumference. Drive plates 7 are axially elastically connected, for example, to an annular chamber for the disc parts forming the spring device for radially outward isolation of axial, wobble, and/or slide vibration, said disc parts forming a primary flywheel mass with other components, for example, a starter ring gear, if necessary ring masses and the like. Instead of drive plates 4, 7, a disc part, which is substantially axially rigid, may be provided, which forms an annular chamber with a cover part.

Fastening openings, not visible in this depiction, are provided distributed across the circumference in input part 2 and offset across the circumference at the radial height of rivets 8. Torsional vibration damper 1 is screwed to a crankshaft of an internal combustion engine by means of screws through these fastening openings.

Output part 3 has output hub 9 and flange part 10 biasing the spring device on the output side. Output hub 9 and flange part 10 are connected to each other by means of main rivet 11.

Input part 2 and output part 3 are rotatable relative to one another about axis of rotation d and are mounted on one another against the action of the spring device. For this purpose, rolling bearing 12, designed here as a grooved ball bearing, is arranged between input part 2 and output part 3. Bearing dome 6 has bearing seat 13 on which inner ring 14 of rolling bearing 12 is pressed.

Output hub 9 is designed as two parts and has hub part 15 and ring part 16. Hub part 15 has internal toothing 17 and is produced from sheet metal by means of a stamping/shaping method. In the exemplary embodiment shown, the internal toothing is broached. Alternatively, hub part 15 may be designed with a pushed-in internal toothing, for example, using a tool.

Ring part 16 is produced from sheet metal using a tool and has an L-shaped cross section with legs 18, 19. Radial leg 18 is riveted to hub part 15 by means of rivets 20 arranged distributed across the circumference. Rivets 20 are arranged in the flange part substantially at the radial height of rivets 8 and the fastening openings and offset in the circumferential direction with respect to the fastening openings.

Axial leg 19 contains bearing seat 21, designed using tools, on which outer ring 22 of rolling bearing 12 is pressed.

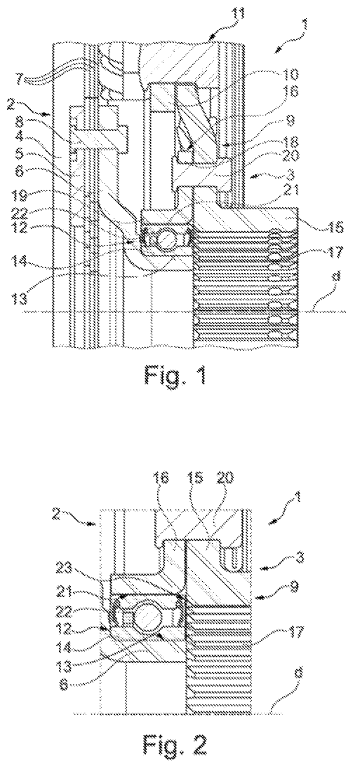

FIG. 2 shows a detail of torsional vibration damper 1 from FIG. 1 in the area of rolling bearing 12. Divided output hub 9 is joined, in that ring part 16 is held on hub part 15, centered about axis of rotation d, and riveted to hub part 15 by means of rivet 20.

After the riveting of ring part 16 to hub part 15, rolling bearing 12 is pressed radially outside of inner toothing 17 axially against contact surface 23 of hub part 15 with its outer ring 22 on bearing seat 21 of ring part 16.

During the insertion of the subassembly of output part 3 into the still open annular chamber of input part 2, inner ring 14 of rolling bearing 12 is pressed through inner toothing 17 onto bearing seat 13 of bearing dome 6. The annular chamber is subsequently tightly sealed, for example, welded to a cover part.

### LIST OF REFERENCE NUMBERS

1 Torsional vibration damper
2 Input part
3 Output part
4 Drive plate
5 Reinforcing disc
6 Bearing dome
7 Drive plate
8 Rivet
9 Output hub
10 Flange part
11 Main rivet
12 Rolling bearing
13 Bearing seat
14 Inner ring
15 Hub part
16 Ring part
17 Internal toothing
18 Leg
19 Leg
20 Rivet
21 Bearing seat
22 Outer ring
23 Contact surface
d Axis of rotation

1. A torsional vibration damper comprising:
an input part rotatably about an axis of rotation;
an output rotatable in relation to the input part about the axis of rotation to a limited extent against an action of a spring device; and
an output hub, wherein a rolling bearing is provided between the input part and the output part, wherein the output hub is designed as divided into a ring part containing an output-side bearing seat and a hub part containing an internal toothing.

2. The torsional vibration damper according to claim 1, wherein the ring part and the hub part are riveted to each other.

3. The torsional vibration damper according to claim 2, wherein a partial circle of rivets arranged distributed across a circumference is arranged in an area of a radius of a partial circle of fastening openings of the input part, wherein the rivets are provided between the fastening openings in a circumferential direction.

4. The torsional vibration damper according to claim 1, wherein an outer ring of the rolling bearing is accommodated on the bearing seat of the ring part and is supported axially on the hub part immediately radially outside of the internal toothing.

5. The torsional vibration damper according to claim 1, wherein the ring part is produced from sheet metal and the bearing seat is introduced using a tool or machining.

6. The torsional vibration damper according to claim 1, wherein the hub part is produced from sheet metal.

7. The torsional vibration damper according to claim 6, wherein the internal toothing is produced by broaching or using a tool.

8. The torsional vibration damper according to claim 1, wherein the ring part and the hub part are connected to one another centered on one another.

9. The torsional vibration damper according to claim 1, wherein an inner ring of the rolling bearing is accommodated on a bearing seat of a bearing dome of the input part.

10. The torsional vibration damper according to claim 1, wherein a ring mass and/or centrifugal force pendulum is arranged on the output part.

11. A torsional vibration damper, comprising:
an input part mounted rotatably about an axis of rotation;
an output part rotatable relative to the input part about the axis of rotation;
a rolling bearing disposed between the input part and the output part; and
an output hub including a ring part having an output-side bearing seat and a hub part, wherein an outer ring of the rolling bearing is arranged on the bearing seat of the ring part and is supported axially on the hub part.

12. The torsional vibration damper according to claim 11, wherein the ring part and the hub part are connected to each other radially outside of the rolling bearing.
